(19) United States
(12) Patent Application Publication
(10) Pub. No.: US 2010/0019719 A1
(43) Pub. Date: Jan. 28, 2010

(54) Information rewriting device and recording medium

(75) Inventor: Hisakazu Okabayashi, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, Anjo-Shi (JP)

(21) Appl. No.: 12/458,147

(22) Filed: Jul. 1, 2009

(30) Foreign Application Priority Data
Jul. 25, 2008 (JP) 2008-192456

(51) Int. Cl. H02J 7/00

(52) U.S. Cl. 320/106

(57) ABSTRACT

An information rewriting device includes a first storage unit provided in a battery, a second storage unit provided in a battery charger, and at least one rewrite unit provided in at least one of the battery and the battery charger. When the battery and the battery charger are electrically connected, the at least one rewrite unit rewrites one of a first information stored in the first storage unit and a second information stored in the second storage unit based on the other.

### CROSS-REFERENCE TO RELATED APPLICATIONS

This application claims the benefit of Japanese Patent Application No. 2008-192456 filed Jul. 25, 2008 in the Japan Patent Office, the disclosure of which is incorporated herein by reference.

### BACKGROUND

The present invention relates to a technique for rewriting information stored in a battery and a battery charger.

In part of a general charging system which includes a battery and a battery charger, the battery and the battery charger respectively have storage media, where charge characteristic data of the battery are stored.

Here, charge characteristics required are diversified depending on how the battery is used. Because of this, it is preferable that the charge characteristic data, which are stored in the battery and the battery charger, can be changed as appropriate.

An example of technique devised to change charge characteristic data as appropriate is disclosed in Unexamined Patent Application Publication No. 2001-298870. In the example, a user connects a battery and a battery charger separately to a terminal device connected to the Internet. Then, the user operates the terminal device to obtain charge characteristic data from a server device on the Internet, and rewrites data stored in the battery or the battery charger, which are connected to the terminal device, based on the data obtained from the server device.

### SUMMARY

In the above example, it is far from easy for any user to rewrite data since the user is required to have a knowledge of terminal device operation and the like.

In one aspect of the present invention, it is preferable for a user to easily rewrite information stored in a battery and a battery charger.

An information rewriting device according to a first aspect of the present invention includes a first storage unit, a second storage unit, and at least one rewrite unit.

The first storage unit is provided in a battery, and rewritably stores a first information.

The second storage unit is provided in a battery charger, and rewritably stores a second information. The battery charger charges the battery by being electrically connected to the battery detachably therefrom.

The at least one rewrite unit is provided in at least one of the battery and the battery charger. When the battery and the battery charger are electrically connected, the at least one rewrite unit rewrites one information out of the first information stored in the first storage unit and the second information stored in the second storage unit based on the other information out of the first information and the second information.

According to the information rewriting device configured as above, a user is not required to separately carry out an operation to rewrite the information since one of the first information stored in the battery and the second information stored in the battery charger is rewritten based on the other only by electrically connecting the battery and the battery charger.

Consequently, according to the first aspect of the present invention, the user can easily rewrite the information stored in the battery and the battery charger.

The at least one rewrite unit may be two rewrite units, which may include a first rewrite unit, which is provided in the battery and rewrites the second information stored in the second storage unit provided in the battery charger, and a second rewrite unit, which is provided in the battery charger and rewrites the first information stored in the first storage unit provided in the battery.

In this case, the information rewriting device may include a first determination unit, a first operation inhibiting unit, a second determination unit, and a second operation inhibiting unit.

The first determination unit is provided in the battery, and determines whether or not the first information should be rewritten, based on contents of the first information and the second information.

The first operation inhibiting unit is provided in the battery, and inhibits an operation of the first rewrite unit when the first determination unit determines that the first information should be rewritten.

The second determination unit is provided in the battery charger, and determines whether or not the second information should be rewritten, based on contents of the first information and the second information.

The second operation inhibiting unit is provided in the battery charger, and inhibits an operation of the second rewrite unit when the second determination unit determines that the second information should be rewritten.

The information rewriting device configured as above can reduce a possibility that the second information may be rewritten based on the first information when the first information should be rewritten, as well as a possibility that the first information may be rewritten based on the second information when the second information should be rewritten.

The first determination unit and the second determination unit may determine whether or not the first information should be rewritten and whether or not the second information should be rewritten in any manner.

For example, in a case where the first information and the second information include an update information indicating update histories of the first information and the second information, at least one of the first determination unit and the second determination unit may refer to the update information included in the first information and the second information, and may make a determination based on the update information.

According to the information rewriting device configured as above, information which should be rewritten may be identified and rewritten based on the update information included in the first information and the second information.

The at least one rewrite unit may include a writing unit, a success determination unit, and an overwriting unit.

When rewriting the one information, the writing unit writes the other information into one storage area other than another storage area where the one information is stored, in the storage unit out of the first storage unit and the second storage unit where the one information is stored.

The success determination unit determines whether or not a write by the writing unit succeeds, based at least on the other information written in the one storage area.

When the success determination unit determines that the write by the writing unit succeeds, the overwriting unit writes the other information written in the one storage area by the writing unit over the another storage area where the one information is stored.

According to the information rewriting device configured as above, the information to be rewritten can be inhibited from being rewritten based on incomplete or erroneous information, when information transmission between the battery and the battery charger ended in failure.

When writing the other information over the another storage area where the one information is stored, the overwriting unit may write the other information after deleting the one information, or may overwrite the one information with the other information without deleting the one information.

The above-described information rewriting device may include at least one notification unit. The at least one notification unit is provided in at least one of the battery and the battery charger, and notifies a completion of a rewrite by the at least one rewrite unit when the rewrite has been completed.

According to the information rewriting device configured as above, the user can easily grasp whether or not the information rewrite has been completed. This can reduce a possibility that the user may detach the battery from the battery charger although the information rewrite has not been completed yet.

The notification unit may notify the completion of the rewrite in any manner, for example, using light, sound, vibration, display, and the like.

Furthermore, the above-described information rewriting device may include a charge initiating unit. The charge initiating unit is provided in the battery charger, and initiates a charging of the battery after a rewrite by the at least one rewrite unit has been completed.

According to the information rewriting device configured as above, electrical noise caused by electric current flowing through the battery and the battery charger for the charging can be inhibited from affecting the rewrite of the information.

In a case where the battery includes a computer, the first information may be a program executed by the computer.

In a case where the battery charger includes a computer, the second information may be a program executed by the computer.

In this case, the user can easily rewrite the program executed by the computer in the battery and the program executed by the computer in the battery charger with the information rewriting device.

The first information and the second information may be any program.

For example, the first information and the second information may be programs for controlling the charging of the battery by the computer in the battery and the computer in the battery charger.

In this case, the user can easily rewrite the programs for controlling the charging of the battery with the information rewriting device. This enables the user to easily change charge characteristics of the battery and the battery charger, for example.

The information rewriting device may include a protocol changing unit which changes a communication protocol between the battery and the battery charger from a first protocol to a second protocol when the at least one rewrite unit rewrites the one information.

In this case, if the second protocol is configured to a protocol more appropriate to rewrite the one information than the first protocol, the one information can be preferably rewritten.

The information rewriting device may include a protocol controlling unit which determines whether or not it is possible to change the communication protocol between the battery and the battery charger from the first protocol to the second protocol, allows the protocol changing unit to operate when the change is determined to be possible, and inhibits the protocol changing unit from operating when the change is determined to be impossible.

According to the information rewriting device configured as above, in a case where the communication protocol between the battery and the battery charger can be changed from the first protocol to the second protocol, the one information can be rewritten using the second protocol. On the other hand, in a case where the communication protocol cannot be changed from the first protocol to the second protocol, the one information can be rewritten using the first protocol.

A second aspect of the present invention is a program for allowing a computer to function as a rewrite unit which rewrites one information out of a first information and a second information based on the other information out of the first information and the second information. The first information is stored in a first storage unit, which is provided in a battery and rewritably stores the first information. The second information is stored in a second storage unit, which is provided in a battery charger, which charges the battery, and rewritably stores the second information.

According to such a program, the computer is enabled to function as the rewrite unit.

The above-described computer may be a known computer or a computer preferably configured for the battery or the battery charger.

The above-described program may be stored in a ROM or a backup RAM, which are installed in the computer, and used after being loaded to the computer from the ROM or the backup RAM, or may be used after being loaded to the computer via network.

Furthermore, the above-described program may be used after being recorded in a computer-readable recording medium. Such a recording medium includes, for example, a flexible disk (FD), an optical disk (MO), a DVD, a CD-ROM, a Blu-ray disc, an HD-DVD, a hard disk, a portable semiconductor memory (e.g., a USB memory, a memory card), and the like.

A third aspect of the present invention is a battery which includes the first storage unit and the at least one rewrite unit in the information rewriting device of the first aspect.

When using such a battery, it is not necessary for the user to separately carry out an operation to rewrite the information stored in the battery or the information stored in the battery charger which is electrically connected to the battery and charges the battery.

A fourth aspect of the present invention is a battery charger which includes the second storage unit and the at least one rewrite unit in the information rewriting device of the first aspect.

When using such a battery charger, it is not necessary for the user to separately carry out an operation to rewrite the information stored in the battery charger or the information stored in the battery which is electrically connected to the battery charger and charged by the battery charger.

A fifth aspect of the present invention is a charging system which includes the battery of the third aspect and the battery charger of the fourth aspect.

In such a charging system, it is not necessary for the user to separately carry out an operation to rewrite the information stored in the battery or the information stored in the battery charger which is electrically connected to the battery and charges the battery.

The charging system may be configured to allow the battery to be electrically connectable to the battery charger by sliding the battery on the battery charger.

In this case, the user can easily rewrite the first information stored in the battery or the second information stored in the battery charger only by sliding the battery on the battery charger.

### BRIEF DESCRIPTION OF THE DRAWINGS

The present invention will now be described by way of example with reference to the accompanying drawings, in which:

FIG. 1 is a perspective view of a battery according to the present invention showing an exterior appearance of the battery;

FIG. 2 is a perspective view of a battery charger according to the present invention showing a front-side exterior appearance of the battery charger;

FIG. 3 is a perspective view of the battery charger showing a back-side exterior appearance of the battery charger;

FIG. 4 is a block diagram simply showing an electrical configuration of the battery and an electrical configuration of the battery charger;

FIG. 5 is a flowchart showing a flow of a first rewrite process;

FIG. 6 is a flowchart showing a flow of a second rewrite process;

FIG. 7 is a flowchart showing a flow of a write source process; and

FIG. 8 is a flowchart showing a flow of a write destination process.

### DETAILED DESCRIPTION OF THE PREFERRED EMBODIMENTS

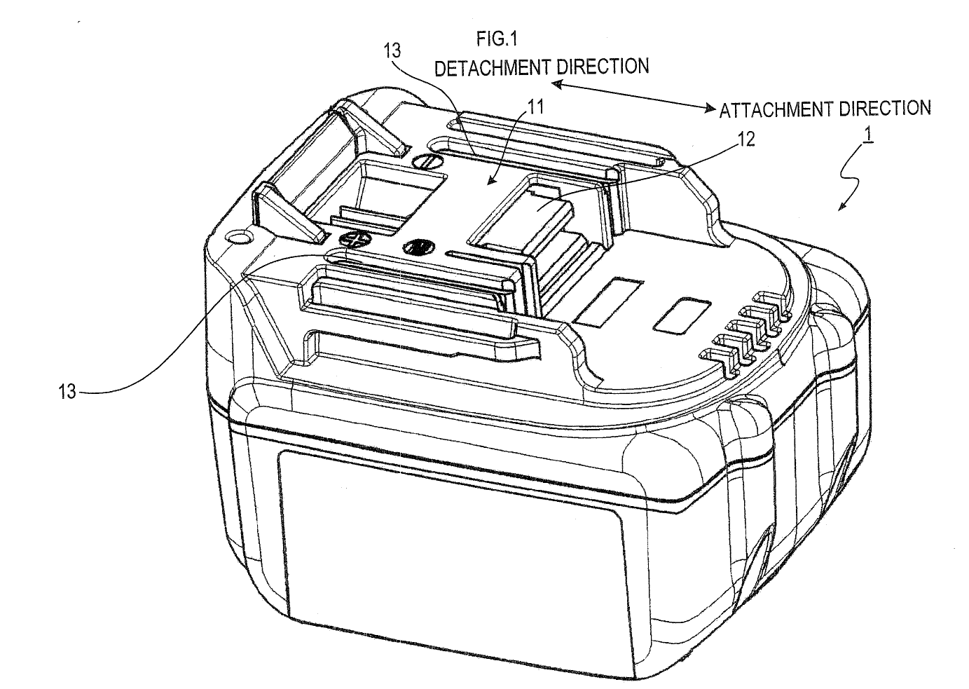

As shown in FIG. 1, a battery 1 is provided with an apparatus attachment portion 11 on an upper side thereof. The apparatus attachment portion 11 is configured to be attachable to and detachable from a battery charger by being slided on the battery charger. In the vicinity of the central part of the apparatus attachment portion 11, there are provided a communication connector 12 and a pair of electrode connectors 13. More specifically, the communication connector 12 is arranged between the pair of electrode connectors 13.

The communication connector 12 is configured as a male connector, which protrudes toward an attachment direction to the battery charger. The pair of electrode connectors 13 is configured to allow a positive side electrode terminal and a negative side electrode terminal on the side of the battery charger to be slided inside the pair of electrode connectors 13.

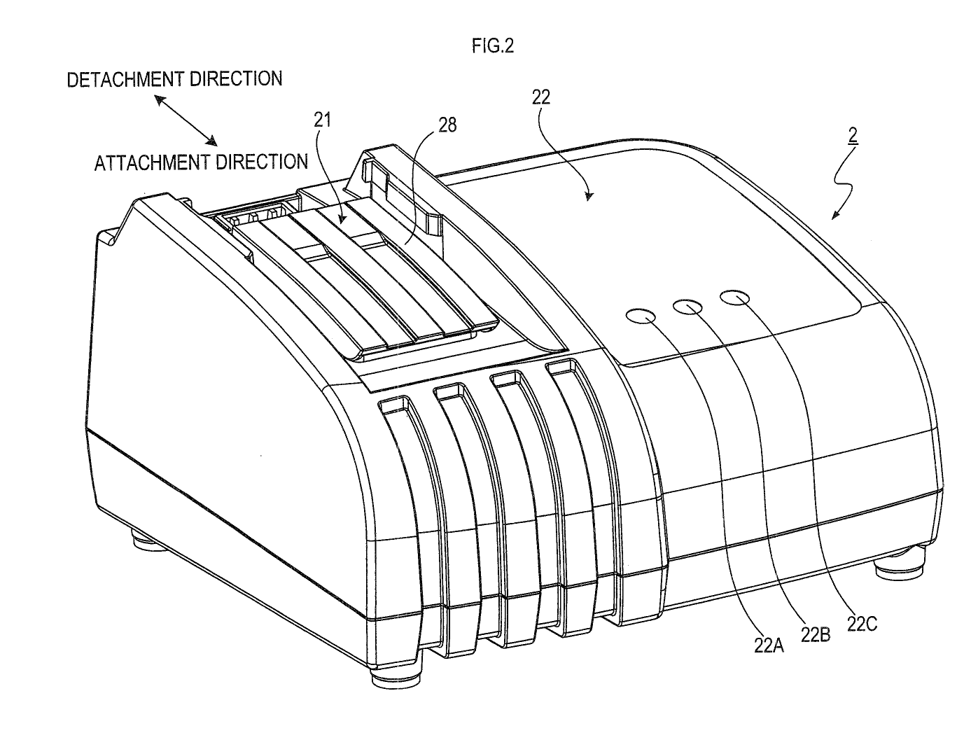

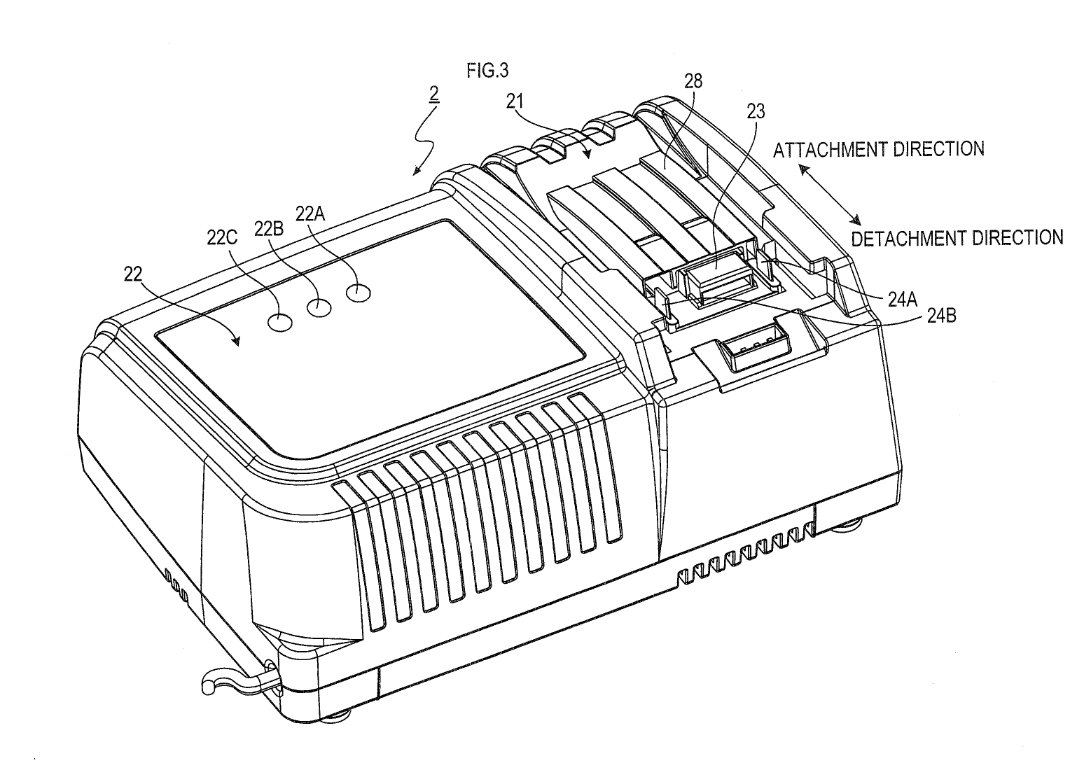

As shown in FIGS. 2 and 3, a battery charger 2 is provided with a battery attachment portion 21 and a display portion 22 on an upper side thereof.

The battery 1 is attached to the battery attachment portion 21 with the apparatus attachment portion 11 of the battery 1 facing downward. More specifically, the battery attachment portion 21 is configured to allow the apparatus attachment portion 11 of the battery 1 to be slided on the battery charger 2 while guiding the battery 1 along the attachment direction to the battery charger 2. And the battery attachment portion 21 is provided with a protection cover 28, a communication connector 23, a positive side electrode terminal 24A, and a negative side electrode terminal 24B.

More specifically, the protection cover 28, which is slidably provided on the battery attachment portion 21, covers the communication connector 23, the positive side electrode terminal 24A, and the negative side electrode terminal 24B when the battery 1 is yet to be attached to the battery attachment portion 21, whereas the protection cover 28 exposes the communication connector 23, the positive side electrode terminal 24A, and the negative side electrode terminal 24B to the battery 1 when the battery 1 is attached to the battery attachment portion 21.

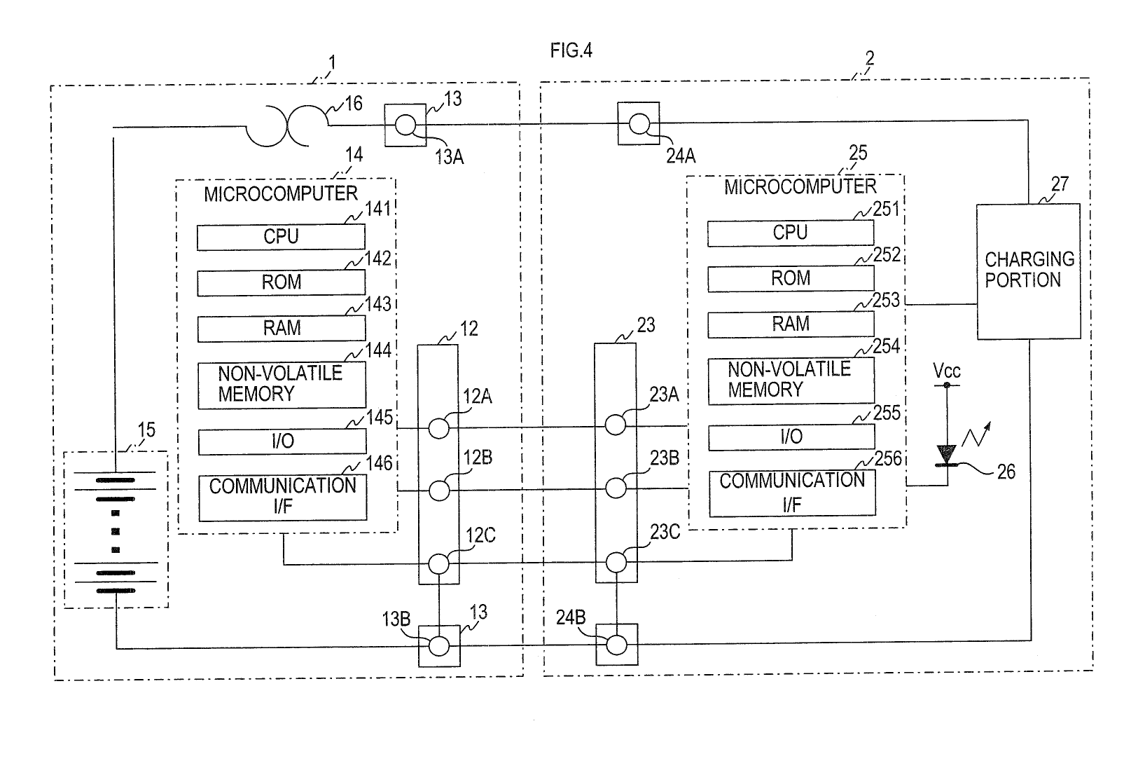

The communication connector 23 is arranged between the positive side electrode terminal 24A and the negative side electrode terminal 24B. The communication connector 23 is configured as a female connector, which is fitted with the above-described communication connector 12 of the battery 1. Furthermore, a plurality of connection terminals, which are electrically connected to a plurality of communication terminals provided in the communication connector 12, are provided inside the communication connector 23. The positive side electrode terminal 24A, which is a plate-shaped terminal protruding upward of the battery charger 2, is guided by one of the electrode connectors 13 of the battery 1, and is electrically connected to a positive side electrode terminal 13A (see FIG. 4) provided inside the electrode connector 13. The negative side electrode terminal 24B, which is a plate-shaped terminal protruding upward of the battery charger 2 just as the positive side electrode terminal 24A, is guided by the other of the electrode connectors 13 of the battery 1, and is electrically connected to a negative side electrode terminal 13B (see FIG. 4) provided inside the electrode connector 13.

The display portion 22, which includes three indicator lamps 22A, 22B, and 22C, is configured to display a status of the battery 1 and the battery charger 2 with the indicator lamps 22A, 22B, and 22C. More specifically, the indicator lamps 22A and 22B are lamps for indicating a remaining amount of electric power in the battery 1, and the indicator lamp 22C is a lamp for indicating whether or not a rewrite of a program stored in the battery 1 and a rewrite of a program stored in the battery charger 2 is being carried out.

As shown in FIG. 4, the battery 1 is provided with a microcomputer 14. The microcomputer 14, which is configured as a so-called one-chip microcomputer, has at least a CPU 141, a ROM 142, a RAM 143, a non-volatile memory 144, an input/output (I/O) port 145, and a communication interface (I/F) 146 integrated thereinto.

The non-volatile memory 144 may be any memory element as long as the same can rewrite a memory content, and it is possible to use, for example, an EEPROM and a flash memory as the non-volatile memory 144. In the non-volatile memory 144 of the present embodiment, a program for controlling the charging of the battery 1 (a charging control program) by the microcomputer 14 is rewritably stored. The charging control program includes a version information indicating an update history of the charging control program.

The microcomputer 14 is connected to the plurality of communication terminals provided in the communication connector 12 of the battery 1. More specifically, the microcomputer 14 is connected to a temperature data terminal 12A, a data communication terminal 12B, and a GND terminal 12C.

The temperature data terminal 12A is a terminal for outputting to the battery charger 2 an electrical signal (a temperature signal) outputted from the microcomputer 14 based on a temperature detected by a thermistor (not shown) provided in the battery 1.

The data communication terminal 12B is a terminal for outputting a data signal outputted from the microcomputer 14 to the battery charger 2 and for inputting a data signal outputted from the battery charger 2 to the microcomputer 14.

The GND terminal 12C is a terminal where a reference potential for communication signals transmitted between the battery 1 and the battery charger 2 is set.

The battery 1 includes a cell portion 15, where a plurality of series-connected cells are provided. A positive side of the cell portion 15 is connected to the above-described positive side electrode terminal 13A of the battery 1 via a fuse 16, whereas a negative side of the cell portion 15 is connected to the above-described negative side electrode terminal 13B of the battery 1. The negative side electrode terminal 13B is electrically connected to the above-described GND terminal 12C, and sets a potential of the GND terminal 12C to a potential of a negative electrode of the cell portion 15 (i.e., a potential of a negative electrode of the battery 1).

On the other hand, the battery charger 2 includes a microcomputer 25. The microcomputer 25, which is configured as a one-chip microcomputer just as the microcomputer 14, has at least a CPU 251, a ROM 252, a RAM 253, a non-volatile memory 254, an I/O port 255, and a communication I/F 256 integrated thereinto.

The non-volatile memory 254 may be any memory element, just as the non-volatile memory 144, as long as the same can rewrite memory content, and it is possible to use, for example, an EEPROM and a flash memory as the non-volatile memory 254. In the non-volatile memory 254 of the present embodiment, a program for controlling the charging of the battery 1 (a charging control program) by the microcomputer 25 is rewritably stored. The charging control program includes a version information indicating an update history of the charging control program.

The microcomputer 25 is connected to the plurality of connection terminals provided in the above-described communication connector 23 of the battery charger 2. More specifically, the microcomputer 25 is connected to a temperature data terminal 23A, a data communication terminal 23B, and a GND terminal 23C.

The temperature data terminal 23A, which is electrically connected to the temperature data terminal 12A of the battery 1 when the battery 1 is attached to the battery charger 2, is a terminal for inputting the temperature signal outputted from the microcomputer 14 of the battery 1 to the microcomputer 25.

The data communication terminal 23B, which is electrically connected to the data communication terminal 12B of the battery 1 when the battery 1 is attached to the battery charger 2, is a terminal for inputting the data signal outputted from the microcomputer 14 of the battery 1 to the microcomputer 25 and for outputting the data signal outputted from the microcomputer 25 to the microcomputer 14.

The GND terminal 23C, which is electrically connected to the GND terminal 12C of the battery 1 when the battery 1 is attached to the battery charger 2, is a terminal where the reference potential for communication signals transmitted between the battery 1 and the battery charger 2 is set.

The battery charger 2 includes an LED 26 which is a light source of the indicator lamp 22C. The LED 26 is connected to the microcomputer 25 so as to be turned on and off in accordance with a command from the microcomputer 25. More specifically, in the LED 26, an anode of the LED 26 is connected to a positive electrode Vcc of a power source of the battery charger 2, and a cathode of the LED 26 is connected to the microcomputer 25. Although a plurality of LEDs, which are light sources of the indicator lamps 22A and 22B are not shown in FIG. 4, the battery charger 2 practically includes the plurality of LEDs, which are the light sources of the indicator lamps 22A and 22B.

Furthermore, the battery charger 2 includes a charging portion 27 for supplying electric power to the battery 1 to charge the battery 1. More specifically, a positive side of the charging portion 27 is connected to the above-described positive side electrode terminal 24A of the battery charger 2. That is, the positive side of the charging portion 27 is electrically connected to a positive electrode of the battery 1 (the cell portion 15) via the positive side electrode terminal 24A of the battery charger 2 and the positive side electrode terminal 13A of the battery 1 when the battery 1 is attached to the battery charger 2.

On the other hand, a negative side of the charging portion 27 is connected to the above-described negative side electrode terminal 24B of the battery charger 2. That is, the negative side of the charging portion 27 is electrically connected to the negative electrode of the battery 1 (the cell portion 15) via the negative side electrode terminal 24B of the battery charger 2 and the negative side electrode terminal 13B of the battery 1 when the battery 1 is attached to the battery charger 2. Moreover, the negative side electrode terminal 24B is electrically connected to the above-described GND terminal 23C, and sets a potential of the GND terminal 23C to a potential of a negative electrode of the charging portion 27 (i.e., a potential of the negative electrode of the battery 1).

The charging portion 27 is connected to the microcomputer 25, and configured to charge the battery 1 in accordance with a command from the microcomputer 25.

Hereinafter, processes according to the present invention, which are executed by the CPU 141 of the battery 1 and the CPU 251 of the battery charger 2, will be described.

The CPU 251 initiates a first (primary) rewrite process when detecting that the battery 1 is attached to the battery charger 2 based on the above-described temperature signal.

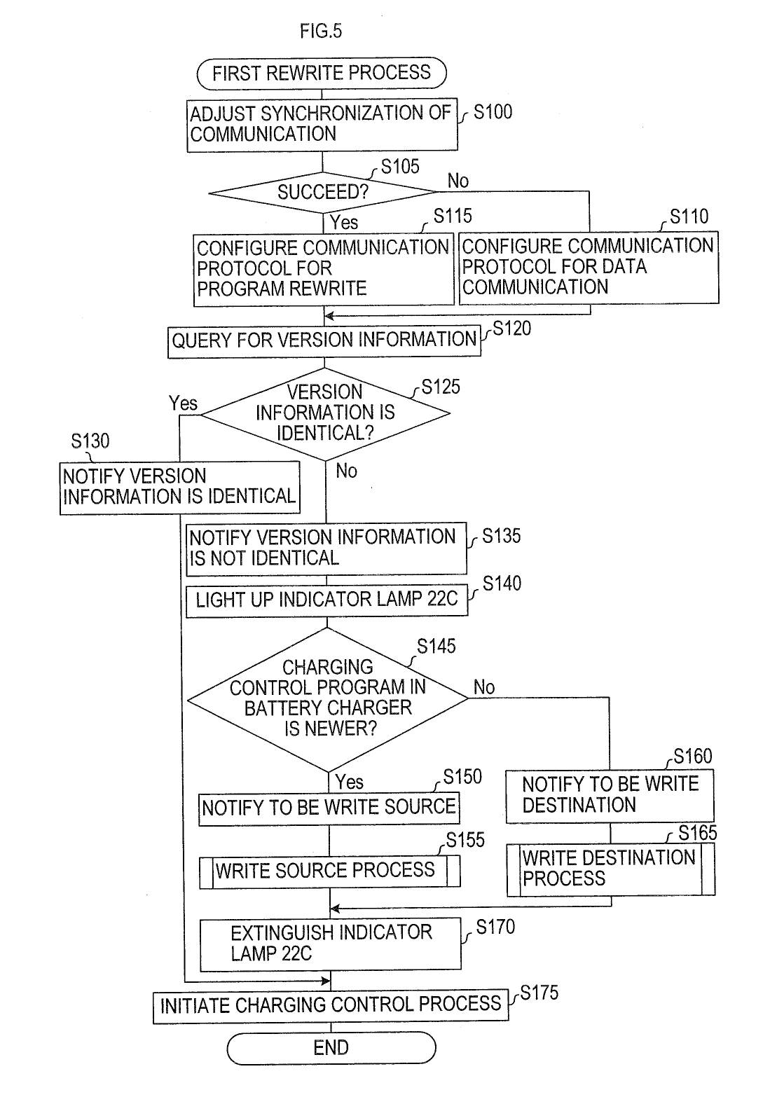

As shown in FIG. 5, in the present process, a synchronization of communication with the battery 1 is initially adjusted (S100) based on a preconfigured communication protocol (a communication protocol for program rewrite) to rewrite a charging control program, which is different from a mere communication protocol for data communication. This communication protocol for program rewrite is so configured as to rewrite the charging control program in less time than required by the communication protocol for data communication.

When the synchronization of communication with the battery 1 based on the communication protocol for program rewrite fails (S105: No), a communication protocol used to communicate with the battery 1 is configured to the communication protocol for data communication (S110), and the process is forwarded to S120 to be described below.

When the synchronization of communication with the battery 1 based on the communication protocol for program rewrite succeeds (S105: Yes), the communication protocol used to communicate with the battery 1 is configured to the communication protocol for program rewrite (S115), and the battery 1 (more specifically, the CPU 141 of the battery 1) is queried for the version information of the charging control program stored in the battery 1 (S120).

It is then determined whether or not the version information received from the battery 1 is identical with the version information of the charging control program stored in the non-volatile memory 254 of the battery charger 2 (S125). When the version information is identical (S125: Yes), the battery 1 is notified that the version information is identical (S130), and the process is immediately forwarded to S175 to be described below.

When the version information is not identical (S125: No), the battery 1 is notified that the version information is not identical (S135), and then the indicator lamp 22C is lit up (S140) by turning on the LED 26. The lighting-up of the indicator lamp 22C enables the user to grasp that the rewrite of the charging control program is to be carried out.

Based on the version information received from the battery 1 and the version information of the charging control program stored in the non-volatile memory 254 of the battery charger 2, it is determined whether or not the charging control program in the battery charger 2 is newer than the charging control program in the battery 1 (S145).

When the charging control program in the battery charger 2 is newer than the charging control program in the battery 1 (S145: Yes), the battery 1 is notified that the battery charger 2 is to be a write source of the charging control program (S150), and after a preconfigured write source process is executed (S155), the process is forwarded to S170 to be described below.

When the charging control program in the battery 1 is newer than the charging control program in the battery charger 2 (S145: No), the battery 1 is notified that the battery charger 2 is to be a write destination of the charging control program (S160), and after a preconfigured write destination process is executed (S165), the indicator lamp 22C is extinguished (S170) by turning off the LED 26. The extinction of the indicator lamp 22C enables the user to grasp that the rewrite of the charging control program has been completed.

When the indicator lamp 22C is extinguished, a charging control process on the side of the battery charger 2, which controls the charging of the battery 1 in accordance with the charging control program, is initiated (S175), and the present process is terminated.

The CPU 141 of the battery 1 initiates a second (secondary) rewrite process when detecting that the battery 1 is attached to the battery charger 2 based on the above-described temperature signal.

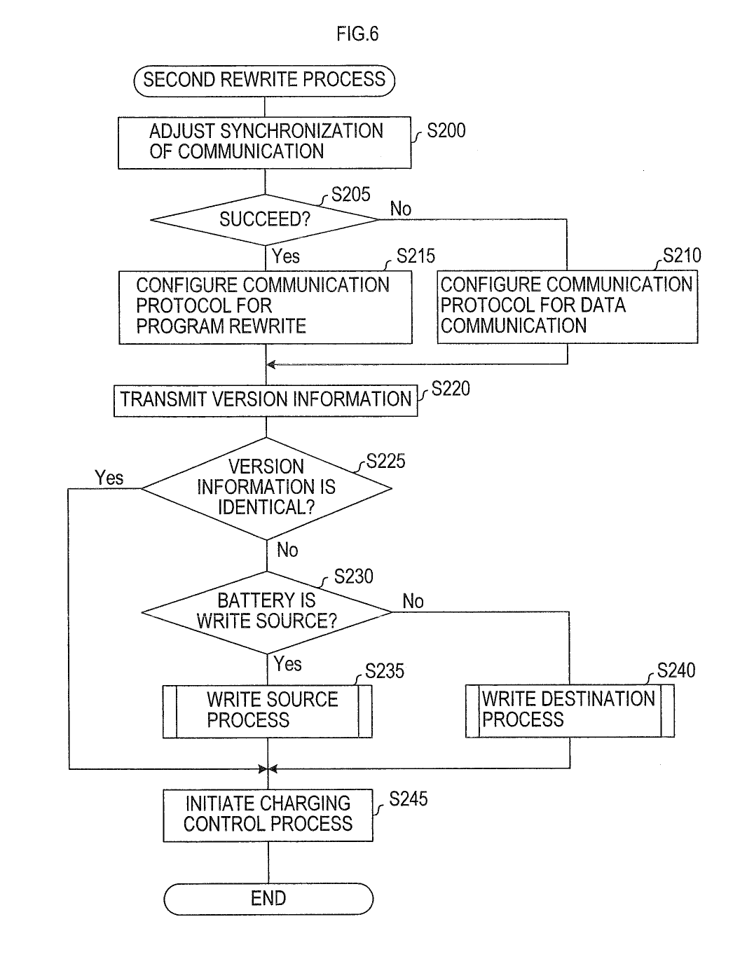

As shown in FIG. 6, in the present process, a synchronization of communication with the battery charger 2 is initially adjusted (S200) based on the above-described communication protocol for program rewrite.

When the synchronization of communication with the battery charger 2 based on the communication protocol for program rewrite fails (S205: No), a communication protocol used to communicate with the battery charger 2 is configured to the communication protocol for data communication (S210), and the process is forwarded to S220 to be described below.

When the synchronization of communication with the battery charger 2 based on the communication protocol for program rewrite succeeds (S205: Yes), a communication protocol used to communicate with the battery charger 2 is configured to the communication protocol for program rewrite (S215).

Then, in response to the query for the version information from the battery charger 2 (the above-described S120), the version information of the charging control program stored in the non-volatile memory 144 is transmitted to the battery charger 2 (S220).

It is then determined whether or not the version information in the battery 1 and the version information in the battery charger 2 are identical (S225) based on the notification from the battery charger 2 (the above-described S130 and S135). When the version information in the battery 1 and the version information in the battery charger 2 are identical (S225: Yes), the process is immediately forwarded to S245 to be described below.

When the version information in the battery 1 and the version information in the battery charger 2 are not identical (S225: No), it is determined whether or not the battery 1 is to be the write source of the charging control program (S230) based on the notification from the battery charger 2 (the above-described S150 and S160).

When the battery 1 is to be the write source (S230: Yes), after a preconfigured write source process is executed (S235), the process is forwarded to S245 to be described below.

When the battery 1 is to be the write destination (S230: No), after a preconfigured write destination process is executed (S240), a charging control process on the side of the battery 1, which controls the charging of the battery 1 in accordance with the charging control program, is initiated (S245), and the present process is terminated.

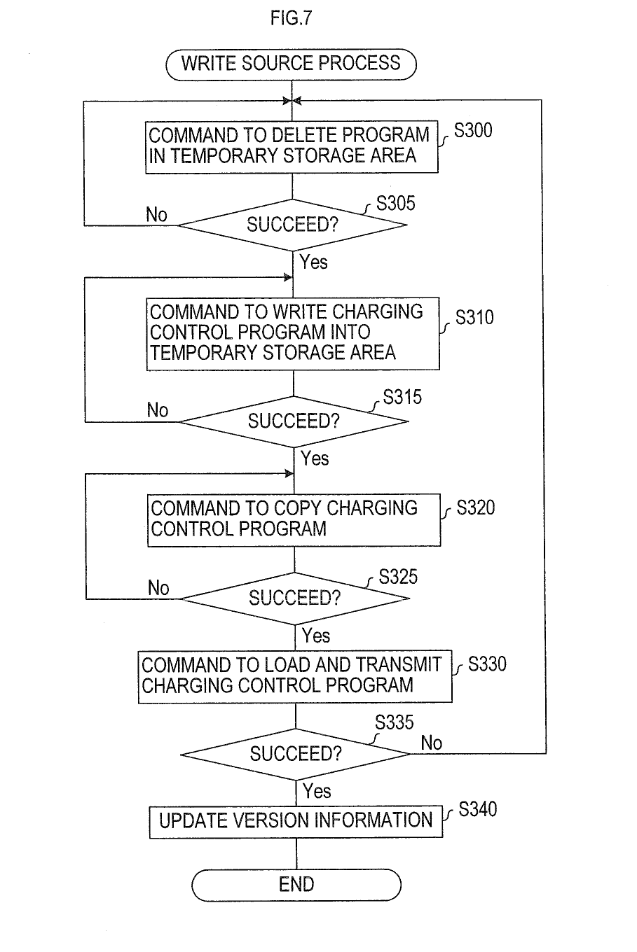

As shown in FIG. 7, in the above-described write source processes (S155 and S235), a command is initially issued to the write destination to delete a program stored in a temporary storage area (RAM) (S300) of the write destination specifying an address of the temporary storage area.

Subsequently, it is determined whether or not a notification that the program is successfully deleted has been received from the write destination (S305), and when the notification has not been received (S305: No), S300 is executed again.

When the notification has been received (S305: Yes), a command is issued to the write destination to write the charging control program in the write source into the temporary storage area of the write destination (S310) specifying the address of the temporary storage area of the write destination.

Subsequently, it is determined whether or not a notification that the program is successfully written has been received from the write destination (S315), and when the notification has not been received (S315: No), S310 is executed again.

When the notification has been received (S315: Yes), a command is issued to the write destination to copy the charging control program in the temporary storage area of the write destination into the non-volatile memory of the write destination (S320) specifying the address of the temporary storage area of the write destination and an address of the non-volatile memory of the write destination. By copying the program into the non-volatile memory, the prior charging control program stored in the non-volatile memory before then is overwritten with the charging control program stored in the temporary storage area.

Subsequently, it is determined whether or not a notification that the program is successfully copied has been received from the write destination (S325), and when the notification has not been received (S325: No), S320 is executed again.

When the notification has been received (S325: Yes), a command is issued to the write destination to load the charging control program stored in the non-volatile memory and transmit the same to the write source (S330) specifying the address of the non-volatile memory of the write destination. Then, by comparing the charging control program received from the write destination and the charging control program stored in the non-volatile memory of the write source, it is determined whether or not the charging control program is successfully written to the write destination (S335).

When the writing fails (S335: No), the above S300 is executed again. When the writing succeeds (S335: Yes), a command is issued to the write destination to update a version information of the charging control program written in the non-volatile memory of the write destination to the version information of the charging control program in the write source (S340), and the present process is terminated.

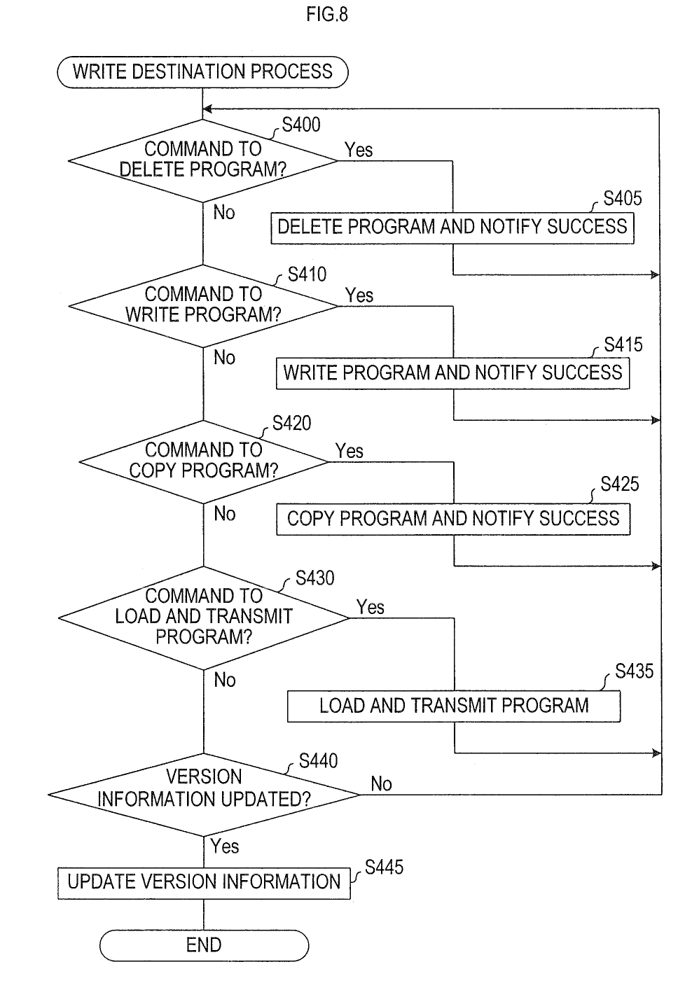

As shown in FIG. 8, in the above-described write destination processes (S165 and S240), it is initially determined whether or not the command has been issued from the write source to delete the program stored in the temporary storage area of the write destination (S400).

When the command to delete the program has been issued (S400: Yes), the program at the address specified by the write source is deleted, and after the write source is notified that the program is successfully deleted (S405), S400 is executed again.

When the command to delete the program has not been issued (S400: No), it is determined whether or not the command has been issued from the write source to write the charging control program in the write source into the temporary storage area of the write destination (S410).

When the command to write the program has been issued (S410: Yes), the charging control program in the write source is written into the address specified by the write source (the temporary storage area of the write destination), and after the write source is notified that the program is successfully written (S415), S400 is executed again.

When the command to write the program has not been issued (S410: No), it is determined whether or not the command has been issued from the write source to copy the charging control program in the temporary storage area of the write destination into the non-volatile memory of the write destination (S420).

When the command to copy the program has been issued (S420: Yes), the charging control program at the address of the temporary storage area of the write destination specified by the write source is copied into the address of the non-volatile memory of the write destination specified by the write source, and after the write source is notified that the program is successfully copied (S425), S400 is executed again.

When the command to copy the program has not been issued (S420: No), it is determined whether or not the command has been issued from the write source to load the charging control program in the non-volatile memory of the write destination and transmit the same to the write source (S430).

When the command to load and transmit the charging control program has been issued (S430: Yes), the charging control program at the address of the non-volatile memory of the write destination specified by the write source is loaded and transmitted to the write source (S435), and S400 is executed again.

When the command to load and transmit the charging control program has not been issued (S430: No), it is determined whether or not the command has been issued from the write source to update the version information (S440).

When the command to update the version information has not been issued (S440: No), S400 is executed again.

When the command to update the version information has been issued (S440: Yes), the version information of the charging control program in the non-volatile memory of the write destination is updated to the version information of the charging control program in the write source (S445), and the present process is terminated.

As described above, in the battery 1 and the battery charger 2 of the present embodiment, one of the charging control program stored in the battery 1 and the charging control program stored in the battery charger 2 is rewritten based on the other only by attaching the battery 1 to the battery charger 2 to electrically connect the battery 1 and the battery charger 2.

This eliminates a need for the user to separately carry out an operation to rewrite the charging control program.

Consequently, according to the present embodiment, the user can easily rewrite the charging control program stored in the battery 1 and the battery charger 2 only by sliding the battery 1 on the battery charger 2 to attach the battery 1 to the battery charger 2. In short, the user can easily change charge characteristics in the battery 1 and the battery charger 2.

According to the battery 1 and the battery charger 2 of the present embodiment, it is determined based on the version information whether the charging control program in the battery 1 should be rewritten or the charging control program in the battery charger 2 should be rewritten, whereby a possibility that a newer charging control program may be rewritten based on an older charging control program can be reduced.

According to the battery 1 of the present embodiment, as long as a new charging control program is stored in the battery 1, an old charging control program stored in a battery charger can be updated only by connecting the battery 1 to the battery charger.

According to the battery charger 2 of the present embodiment, as long as a new charging control program is stored in the battery charger 2, an old charging control program stored in a battery can be updated only by connecting the battery to the battery charger 2.

According to the battery 1 and the battery charger 2 of the present embodiment, when rewriting the charging control program, the charging control program in the write source is written into the temporary storage area of the write destination, and when the program has been successfully written into the temporary storage area, the program is written over the non-volatile memory of the write destination.

This reduces a possibility that the charging control program in the write destination may be rewritten based on an incomplete or erroneous charging control program caused by a failure in transmission between the battery 1 and the battery charger 2.

According to the battery charger 2 of the present embodiment, it is notified that the rewrite of the charging control program is in progress by keeping the indicator lamp 22C on during the rewrite of the charging control program, whereas it is notified that the rewrite of the charging control program has been completed by extinguishing the indicator lamp 22C upon completion of the rewrite of the charging control program, whereby the user can easily grasp whether or not the rewrite of the charging control program has been completed. This can reduce a possibility that the user may detach the battery 1 from the battery charger 2 although the rewrite of the charging control program has not been completed yet.

According to the battery 1 and the battery charger 2 of the present embodiment, battery charging is initiated after the rewrite of the charging control program has been completed, which can reduce a possibility that electrical noise caused by electric current flowing through the battery 1 and the battery charger 2 for the charging may affect the rewrite of the charging control program.

Although the embodiments of the present invention have been described above, it is to be appreciated that the present invention is not limited to the above embodiments and can be modified in various manners within the technical scope of the present invention.

For example, although the completion of the rewrite of the charging control program is notified by extinguishing the lighted indicator lamp 22C in the above embodiment, it may be notified by sound, vibration, display, and the like.

Also, although the lamp for notifying that the rewrite of the charging control program has been completed is provided only in the battery charger 2 in the above embodiment, such a lamp may be also provided in the battery 1. In this case, the indicator lamp 22C may be eliminated from the battery charger 2.

In addition, although both of the battery 1 and the battery charger 2 are configured to be the write source and the write destination of the charging control program in the above embodiment, the battery 1 and the battery charger 2 may be configured so that one of the battery 1 and the battery charger 2 is to be the write source only and the other of the battery 1 and the battery charger 2 is to be the write destination only.

Further, although the charging control program is rewritten in the above embodiment, a program, data, and the like other than the charging control program may be rewritten.

What is claimed is:

1. An information rewriting device comprising:
a first storage unit provided in a battery, rewritably storing a first information;
a second storage unit provided in a battery charger which charges the battery by being electrically connected to the battery detachably therefrom, the second storage unit rewritably storing a second information; and
at least one rewrite unit provided in at least one of the battery and the battery charger, the at least one rewrite unit rewriting one information out of the first information stored in the first storage unit and the second information stored in the second storage unit based on the other information out of the first information and the second information when the battery and the battery charger are electrically connected.

2. The information rewriting device according to claim 1, wherein
the at least one rewrite unit is two rewrite units, the two rewrite units including:
a first rewrite unit provided in the battery, rewriting the second information stored in the second storage unit provided in the battery charger; and
a second rewrite unit provided in the battery charger, rewriting the first information stored in the first storage unit provided in the battery, and
the information rewriting device further comprises:
a first determination unit provided in the battery, determining whether or not the first information should be rewritten, based on a content of the first information and a content of the second information;
a first operation inhibiting unit provided in the battery, inhibiting an operation of the first rewrite unit when the first determination unit determines that the first information should be rewritten;
a second determination unit provided in the battery charger, determining whether or not the second information should be rewritten, based on the content of the first information and the content of the second information; and
a second operation inhibiting unit provided in the battery charger, inhibiting an operation of the second rewrite unit when the second determination unit determines that the second information should be rewritten.

3. The information rewriting device according to claim 2, wherein
the first information and the second information include an update information which indicates update histories of the first information and the second information, and
at least one of the first determination unit and the second determination unit refers to the update information included in the first information and the second information, and makes a determination based on the update information.

4. The information rewriting device according to claim 1, wherein
the at least one rewrite unit includes:
a writing unit which, when rewriting the one information, writes the other information into one storage area other than another storage area where the one information is stored, in the storage unit out of the first storage unit and the second storage unit where the one information is stored;
a success determination unit which determines whether or not a write by the writing unit succeeds, based at least on the other information written in the one storage area; and
an overwriting unit which writes the other information written in the one storage area by the writing unit over the another storage area where the one information is stored, when the success determination unit determines that the write by the writing unit succeeds.

5. The information rewriting device according to claim 1, further comprising:
at least one notification unit provided in at least one of the battery and the battery charger, notifying a completion of a rewrite by the at least one rewrite unit when the rewrite has been completed.

6. The information rewriting device according to claim 1, further comprising:
a charge initiating unit provided in the battery charger, initiating a charging of the battery after a rewrite by the at least one rewrite unit has been completed.

7. The information rewriting device according to claim 1, wherein
the battery and the battery charger respectively include computers,
the first information is a program executed by the computer in the battery, and
the second information is a program executed by the computer in the battery charger.

8. The information rewriting device according to claim 7, wherein
the first information and the second information are programs for controlling the charging of the battery by the computer in the battery and the computer in the battery charger.

9. The information rewriting device according to claim 1, further comprising:
a protocol changing unit which changes a communication protocol between the battery and the battery charger from a first protocol to a second protocol when the at least one rewrite unit rewrites the one information.

10. The information rewriting device according to claim 9, further comprising:
a protocol control unit which determines whether or not it is possible to change the communication protocol between the battery and the battery charger from the first protocol to the second protocol, allows the protocol changing unit to operate when the change is determined to be possible, and inhibits the protocol changing unit from operating when the change is determined to be impossible.

11. A computer-readable recording medium, on which a program is recorded for allowing a computer to function as a rewrite unit which rewrites one information out of a first information and a second information based on the other information out of the first information and the second information, the first information being stored in a first storage unit which is provided in a battery and rewritably stores the first information, and the second information being stored in a second storage unit which is provided in a battery charger, which charges the battery, and rewritably stores the second information.
